(19) United States
(12) Patent Application Publication
(10) Pub. No.: US 2016/0074286 A1
(43) Pub. Date: Mar. 17, 2016

(54) Cooling Pacifier

(71) Applicants: Brittney Carter, Richmond, TX (US); Patrick Carter, Richmond, TX (US)

(72) Inventors: Brittney Carter, Richmond, TX (US); Patrick Carter, Richmond, TX (US)

(21) Appl. No.: 14/850,235

(22) Filed: Sep. 10, 2015

Related U.S. Application Data
(60) Provisional application No. 62/049,499, filed on Sep. 12, 2014.

(51) Int. Cl. A61J 17/00

(52) U.S. Cl. CPC A61J 17/001

(57) ABSTRACT

The invention provides for an infant pacifier that is configured to sooth an infant's discomfort during teething where the pacifier is filled with a freezable liquid or gel that stays cool over a prolonged period of time. The pacifier comprises a sucking portion, a shield portion, a handling means and a hollow cavity, the hollow cavity being formed in the sucking portion of the pacifier and filled with the liquid or gel through an opening in the shield portion, the opening having a plugging device to allow refilling of the liquid or gel.

### CROSS-REFERENCE TO RELATED APPLICATIONS

This application claims the benefit of U.S. Provisional Application Ser. No. 62/049,499 filed Sep. 12, 2014, and is incorporated herein in its entirety.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

1. Field of Invention

This invention relates generally to infant care devices and more specifically to infant pacifiers.

2. Description of Prior Art

During the first 18 months of life, the average child makes considerable gains in height and weight, begins teething, develops sensory discrimination, and begins to walk and talk. Children usually begin teething with the emergence of the two bottom front teeth, followed about four to eight weeks later by the four upper teeth, and then about one month later by the two lower incisors. The first molars come in next, followed by the canine or eye teeth.

According to the American Academy of Pediatrics, teething occasionally may cause mild irritability, crying, low-grade temperature, excessive drooling, and a desire to chew on something hard. The gums around the new teeth will swell and be tender. Parents and caregivers are encouraged to soothe the child at this stage by gently rubbing or massaging the child's gums with a finger, or by using a teething device.

Many such teething devices have been proposed in the past that bring about a reduction of the inflammation and thus the associated discomfort of the sore gums. For instance, some devices may rely on a medication released from the teething device to sooth the gums. However, the dosages released from these devices can decrease over time, thereby limiting their effectiveness. In other instances, some of teething devices can be cooled or frozen to aid in soothing the child. The coolant in these devices is typically water, which, while effective in the short term, quickly loses their cooling properties when the water turns to liquid. Moreover, many of these cooling devices are round or ring shaped, which is foreign to the child and does not take advantage of the biological shape of the nipple for natural sucking.

Accordingly, there is a need for a low cost, easy to use cooling pacifier that is capable of remaining cool for extended periods of time and shaped in a manner that encourages a child's natural sucking tendencies.

### SUMMARY OF THE INVENTION

Provided herein is an infant pacifier device configured to sooth an infant's discomfort during teething. Accordingly, the disclosure provides for a pacifier device having a nipple portion coupled to and in fluid communication with a shank portion where the interior volume of said nipple portion and said shank portion form a hollow cavity. The shank portion is coupled to a shield portion where the shield portion contains outwardly extending ears; the shield portion having an opening whereby said hollow cavity is substantially filed with a liquid or gel capable of being frozen. The pacifier also can have a plugging device inserted into said opening thereby forming a leak proof seal.

In another embodiment of the disclosure, the pacifier is made of an elastomeric material.

In a further embodiment, the plugging device is removable and can be inserted into the shield portion opening via friction fit or by a screwing means. In other instances, the plugging device is sealed to the pacifier and is non-removable.

In still another embodiment, the liquid or gel is contained within a sealed packet or bag that is then placed into the hollow cavity.

These and other exemplary features and advantages of the present invention will become clear from the following description with reference to the accompanying drawings.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1A shows a top view of an exemplary embodiment of the present invention.

FIG. 1B is a rear view an exemplary embodiment of the present invention

### DETAILED DESCRIPTION OF THE INVENTION

When infants are in the process of teething, they can feel constant pain and soreness in their gums, resulting in crying and tantrums. Parents, accordingly, can become very frustrated, not only because the infant will not stop crying, but also because the parent can do nothing to readily alleviate the situation. While there are various teething devices available to help infants massage their sore gums, many are far from ideal.

The present invention provides parents and caregivers with a way to relieve their infant's sore gums. The device is a pacifier structure having a human nipple shaped portion, where the nipple shaped portion contains a hollow cavity. The hollow cavity can be filled with a liquid or semi-solid material that can be frozen. After the material is frozen, the infant can use the device to sooth their gums. Such embodiments of the invention are beneficial when compared to other like devices because the soothing action does not depend on the release of certain dosage of a medicinal compound. The soothing action of the pacifier in the instant application is dosage independent and can be reused over and over again without loss of efficacy.

Reference is made herein to the attached drawings. Like reference numerals are used throughout the drawings to depict like or similar elements of the pacifier. For the purposes of presenting a brief and clear description of the present invention, the preferred embodiment will be discussed as used for soothing teething gums and the like. The figures are intended for representative purposes only and should not be considered to be limiting in any respect.

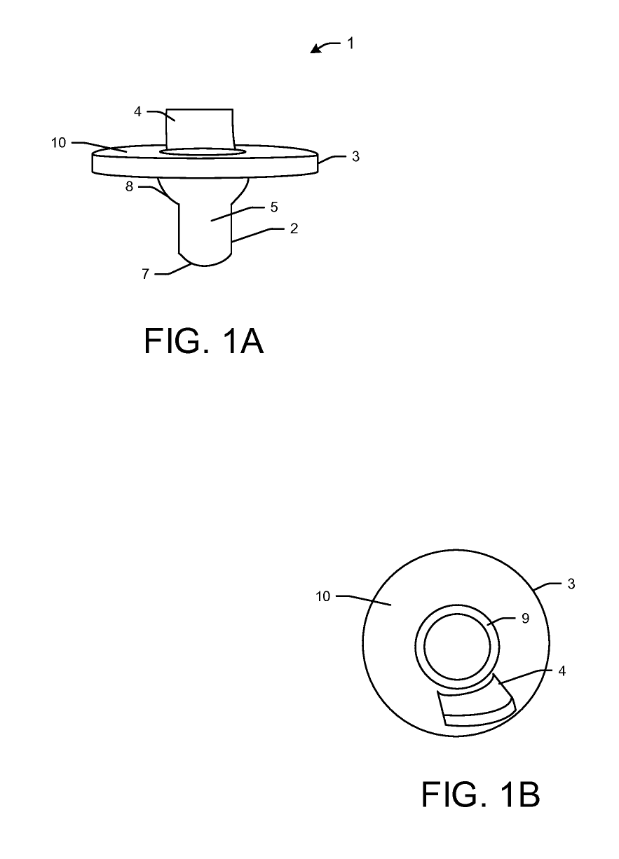

Referring now to FIG. 1A and FIG. 1B, there is shown a top and rear view of the pacifier structure of the present invention, wherein the device is shown in an exemplary embodiment. The pacifier (1) as described herein contains at least one sucking portion (2), a shield or support portion (3), a means for holding the pacifier (4), and a hollow cavity in the sucking portion (5).

Preferably, the sucking portion (2) is shaped and configured to resemble a nipple, for which a child has a natural desire to suckle. The sucking portion generally consists of a shank portion (8) and a nipple portion (7). The shank portion (8) connects the nipple portion (7) with the shield portion (3) and is situated there between. The shank portion (8) can be of various lengths so that the sucking portion (2) can easily fit into a child's mouth. The shank portion (8) and nipple portion (7) are in fluid communication with each other, whereby the shank portion (8) and nipple portion (7) are substantially hollow. Furthermore, the shank portion (8) can also vary in size to hold more or less of a cooling gel or liquid.

The nipple portion (7) is preferably shaped as a nipple. The nipple portion (7) can also be of various sizes to facilitate sucking. Moreover, the nipple portion (7) can be of various sizes to hold more or less of a cooling gel that will be described below.

The shield portion (3) of the pacifier includes a body portion to which the shank portion (8) is integrally connected. The shield portion (3) is preferably oriented substantially perpendicular to the shank portion (8). The shield portion (3) also contains outwardly extending ear portions (10) and is somewhat rigid. The ear portions (10) can be concave, convex or flat and can have the ability to flex between all three positions. The shield portion (3) is sized such that the sucking portion (2) cannot be ingested beyond a certain point to prevent accidental swallowing or choking.

The pacifier also preferably includes a means for holding the pacifier (4). The means for holding the pacifier (4) is preferably integrally connected to the shield portion (3). The means and shape for holding the pacifier can be any means that are known to one skilled in the art.

The pacifier preferably contains a hollow cavity (5) that extends from the shield portion (3), through the shank portion (8) to the distal end of the nipple portion (7). The hollow cavity (5) can have a removable plugging device (9) that inserts into the shield portion (3). The plugging device (9) can snap fit to the shield portion (3), or be screwed in, thus forming a leak proof seal. This allows the hollow cavity (5) to be filled with a gel or liquid and subsequently removed. For instance, a person can fill the hollow cavity (5) with a liquid or gel, insert the plugging device (9) into the opening in the shield portion (3) and freeze the pacifier. After the liquid or gel is frozen, the pacifier is then given to a child to sooth the teething process. After the pacifier is no longer frozen, the plugging device (9) can be removed and the liquid or gel discarded. The pacifier can then be washed or sanitized for reuse. Alternatively, in embodiments where the plug is non-removable, the pacifier can just be refrozen.

In some embodiments, the plugging device is not removable from the shield portion and the hollow cavity is prefilled with a liquid or gel.

Preferably, the sucking portion, shield portion and handle portion are made of a durable, elastomeric material such as a natural or synthetic non-toxic rubber. The sucking portion and hollow cavity is constructed such that it can accommodate the expansion of a liquid or gel when frozen. Preferably, the entire pacifier is molded into a single piece. In other embodiments, each piece of the pacifier assembly is made individually and joined together to a make the final device.

The hollow cavity can accommodate a liquid or gel that can remain cold for prolonged periods of time following refrigeration or freezing. In some embodiments, the liquid or gel can include, for example, water, hydroxypropyl methylcellulose, ammonium nitrate, hydroxyethyl cellulose, silica gel, propylene glycol, or any other food grade, freezer-friendly gel or similar material, or a combination thereof. In addition, the gel or liquid contained in the pacifier may be any liquid and/or other fluid that is non-toxic. Many such fluids are conventionally available that have the freezing/refrigeration properties needed for this pacifier.

In some embodiments, the hollow cavity is directly filled with a liquid or gel. In other embodiments, the liquid or gel in the hollow cavity can be further enclosed in a sealed bag/packet, enclosed expandable plastic material or other container capable of being frozen while holding a liquid and/or gel in order to prevent leakage. The gel packet can lie within the hollow cavity of the pacifier. There may be one or more gel packets in any given pacifier. This will allow the user to replace the frozen liquid or gel rapidly, without need for cleaning the pacifier.

While the invention has been described in terms of several exemplary embodiments, those skilled in the art will recognize that the invention can be practiced with modification within the spirit and scope of the invention.

### Definitions

The following definitions are included to provide a clear and consistent understanding of the specification and claims. As used herein, the recited terms have the following meanings. All other terms and phrases used in this specification have their ordinary meanings as one of skill in the art would understand.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrase “one or more” is readily understood by one of skill in the art, particularly when read in context of its usage.

The scope of the described invention is intended to include all embodiments coming within the meaning of the following claims. The foregoing examples illustrate useful forms of the invention, but are not to be considered as limiting its scope, as those skilled in the art will be aware that additional variants and modifications of the invention can readily be formulated without departing from the meaning of the following claims.

What is claimed is:

1. A pacifier device, comprising:
a nipple portion coupled to and in fluid communication with a shank portion, an interior volume portion of said nipple portion and said shank portion forming a hollow cavity;
said shank potion being coupled to a shield portion, said shield portion having outwardly extending ear portions;
said shield portion having an opening whereby said hollow cavity is substantially filed with a liquid or a gel capable of being frozen; and
a plugging device inserted into said opening thereby forming a leak proof seal.

2. The pacifier device of claim 1, wherein said pacifier is made of an elastomeric material.

3. The pacifier device of claim 1, wherein said plugging device is removable.

4. The pacifier device of claim 3, wherein said plugging device friction fits or is screwed into said shield portion opening.

5. The pacifier device of claim 1, wherein said plugging device is non-removable.

6. The pacifier device of claim 1, wherein said liquid or said gel is contained in a sealed bag or packet that is placed within said hollow cavity.
